(19) United States
(12) Patent Application Publication
(10) Pub. No.: US 2012/0142348 A1
(43) Pub. Date: Jun. 7, 2012

(54) DEVICE AND METHOD FOR REDUCING ELECTRIC CURRENT CONSUMPTION IN DUAL SIM CARD TERMINAL

(75) Inventors: Dae-Gyue PARK, Daegu (KR); Hyun-Muk KIM, Gyeongsangbuk-do (KR); Young-Il NAM, Gyeongsangbuk-do (KR)

(73) Assignee: SAMSUNG ELECTRONICS CO., LTD., Gyeonggi-Do (KR)

(21) Appl. No.: 13/311,998

(22) Filed: Dec. 6, 2011

(30) Foreign Application Priority Data
Dec. 6, 2010 (KR) 10-2010-0123827

(51) Int. Cl. H04W 52/02; H04W 60/00

(52) U.S. Cl. 455/435.1

(57) ABSTRACT

The present disclosure relates to a device and a method for reducing an electric current consumption in a dual SIM card terminal, which reduces the electric current consumed in an idle state of a dual SIM card terminal. The device includes: a first SIM card and a second SIM card; and a controller to make a control so that the first SIM card and the second SIM card perform a signaling through an identical channel for a network registration and maintain the identical channel when a power of the dual SIM card terminal is turned on.

### CLAIM OF PRIORITY

This application claims priority under 35 U.S.C. §119 to a Korean Patent Application entitled “Device and Method for Reducing Electric Current Consumption in Dual SIM Card Terminal” filed in the Korean Intellectual Property Office on Dec. 6, 2010 and assigned Serial No. 10-2010-0123827, the contents of which are incorporated herein by reference.

### BACKGROUND OF THE INVENTION

1. Field of the Invention

The present invention relates to a device and a method for reducing an electric current consumption in a dual SIM card terminal, and more particularly to a device and a method for reducing an electric current consumption during an idle state of a dual SIM card terminal.

2. Description of the Related Art

In general, a SIM card, which is a subscriber identification module card used in a portable terminal, is capable of storing personal information so as to provide various services, such as subscriber identification, charging, and a security function. The SIM card was developed so that a mobile user can readily communicate at any place regardless of a mobile communication technology protocol, such as the CDMA (Code Division Multiple Access) scheme or the GSM (Global System for Mobile Communication) scheme. Among the SIM cards, a subscriber identification module of the UMTS (Universal Mobile Telecommunication System) in the 3^{rd} generation mobile communication is referred to as the USIM (Universal Subscribe Identity Module).

Such a SIM card can be manufactured in a form of a smart card and be inserted in a portable terminal. The portable terminal reads the subscriber information stored in the SIM card and performs an initialization process including an identification process during booting of the portable terminal. Further, the portable terminal can operate using only the authenticated SIM card.

A portable terminal combined with a single SIM card is generally used. However, a portable terminal combined with two SIM cards (hereinafter, referred to as ‘a dual SIM card terminal’) has been recently introduced. In a dual SIM card terminal it is possible to switch the SIM card to be used according to a selection signal of the user. That is, the user can use two telephone numbers with a single terminal equipped with two SIM cards.

During the registration of two SIM cards in a network, the signaling through allocated channels for registration to the network can create a high usage of battery consumption.

### SUMMARY OF THE INVENTION

Accordingly, the present invention has been made to solve the above-stated problems occurring in the prior art, and the present invention provides a device and a method for reducing an electric current consumption in a dual SIM card terminal, which reduces the electric current consumed during an idle state of a dual SIM card terminal.

In accordance with an aspect of the present invention, there is provided a device for reducing an electric current consumption in a dual SIM card terminal, the device including: a first SIM card and a second SIM card; and a controller to make a control so that the first SIM card and the second SIM card perform a signaling through an identical channel for a network registration and maintain the identical channel when a power of the dual SIM card terminal is turned on.

In accordance with an aspect of the present invention, there is provided a method for reducing an electric current consumption in a dual SIM card terminal, the method including: allocating an identical channel to a first SIM card and a second SIM card for a network registration when a power of the dual SIM card terminal is turned on; and when the identical channel is allocated to the first SIM card and the second SIM card, performing, by the first SIM card and the second SIM card, a signaling through the identical channel and maintaining the identical channel.

Accordingly, the method for reducing the electric current consumption in the dual SIM card terminal according to the present invention can allocate only the single channel in the registration to the network and maintain the single identical channel, so that it is effectively possible to reduce the electric current consumption in the idle state of the dual SIM card terminal and extend the duration of the idle time of the dual SIM card terminal.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a dual SIM card terminal according to an exemplary embodiment of the present invention; and

FIG. 2 is a flowchart illustrating a process of reducing the electric current consumption in an idle state of a dual SIM card terminal according to an exemplary embodiment of the present invention.

### DETAILED DESCRIPTION OF THE INVENTION

Hereinafter, the exemplary embodiments of the present invention will be described with reference to the accompanying drawings. For the purposes of clarity and simplicity, a detailed explanation of known related functions and constitutions may be omitted to avoid unnecessarily obscuring the subject matter of the present invention.

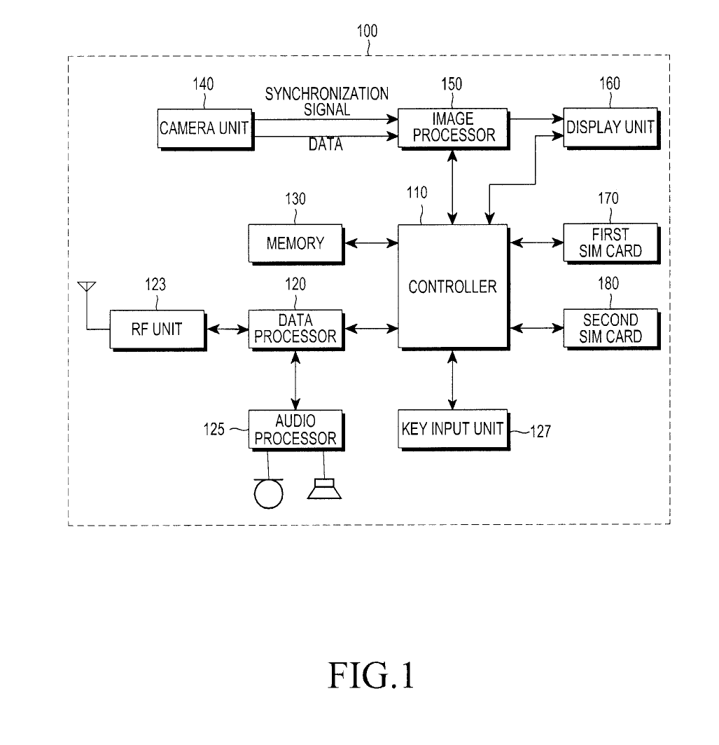

FIG. 1 is a diagram illustrating a dual SIM card terminal according to an exemplary embodiment of the present invention.

Referring to FIG. 1, an RF unit 123 performs a wireless communication function of the dual SIM card terminal. The RF unit 123 includes an RF transmitter for up-converting and amplifying a frequency of a transmitted signal and an RF receiver for low-noise amplifying a received signal and down-converting a frequency. A data processor 120 includes a transmitter for encoding and modulating the transmitted signal and a receiver for demodulating and decoding the received signal. That is, the data processor 120 can be formed with a modem and a codec. Here, the codec includes a data codec for processing packet data, etc. and an audio codec for processing an audio signal, such as voice. An audio processor 125 reproduces a received audio signal output from the audio codec of the data processor 120 or transmits a transmitted audio signal generated in a microphone to the audio codec of the data processor 120.

A key input unit 127 includes keys for inputting numbers and character information and functional keys for setting various functions.

A memory 130 can be formed with a program memory and a data memory. The program memory can store programs for controlling the general operations of the dual SIM card terminal and programs for making a control so that the dual SIM cards perform a signaling through a single identical channel for the registration to the network in an idle state of the dual SIM terminal.

A controller 110 controls the general operations of the dual SIM card terminal.

Briefly, according to the embodiment of the present invention, when the power of the dual SIM card terminal is turned on and is in the idle state, the controller 110 makes a control so that a first SIM card 170 and a second SIM card 180 perform the signaling and maintain the channel through an identical channel for the registration to the network. In this regard, the controller 110 makes a control so that the first SIM card 170 and the second SIM card 180 alternately perform the signaling every predetermined time interval through the identical channel and maintain the identical channel.

According to an embodiment of the present invention, when the power of the dual SIM card terminal is turned on, the controller 110 makes a control so that the first SIM card 170 performs the signaling through the channel allocated from the network according to a request for a registration of the first SIM card 170 and maintains the channel. Then, the controller 110 makes a request for the allocation of the channel identical to that allocated to the first SIM card 170 to the network together with a request for a registration of the second SIM card 180 and makes a control so that the second SIM card 180 performs the signaling through the channel identical to that allocated to the first SIM card 170 from the network and maintains the identical channel. To this end, the controller 110 makes a control so that the first SIM card 170 and the second SIM card 180 alternately perform the signaling at every predetermined time interval through the identical channel and maintain the identical channel. In a portable terminal comprising the first SIM card and the second SIM card according to the embodiment of the present invention, the first SIM card and the second SIM card alternately perform the signaling at every predetermined time interval through the identical channel. Note that each of the first SIM card and the second SIM card alternately performs the signaling at every predetermined time interval through the identical channel.

According to an alternate embodiment of the present invention, when the power of the dual SIM card terminal is turned on, the controller 110 makes a control so that the second SIM card 180 performs the signaling through the channel allocated from the network according to the request for the registration of the second SIM card and maintains the identical channel. Then, the controller 110 makes a request for the allocation of the channel identical to that allocated to the second SIM card 180 to the network together with a request for a registration of the first SIM card 170 and makes a control so that the first SIM card 170 performs the signaling through the channel identical to that allocated to the second SIM card 180 from the network and maintains the identical channel. To this end, the controller 110 makes a control so that the second SIM card 180 and the first SIM card 170 alternately perform the signaling every predetermined time interval through the identical channel and maintain the identical channel.

As described above, in the present invention, the first SIM card 170 and the second SIM card 180 perform the signaling through the identical channel and maintain the identical channel in the registration to the network. It should be noted that the signaling through the identical channel while maintaining the channel can be achieved when the different service providers of the first SIM card and the second SIM card share a frequency, when the service providers of the first SIM card and the second SIM card are the same, or when a service provider of a corresponding SIM card has previously registered allocation of a channel, which is required by the dual SIM card terminal, in the network.

The first SIM card 170 and the second SIM card 180 are the card-type modules and store personal information so as to provide various services, such as the subscriber identification, charging, and the security function. Each of the first SIM card 170 and the second SIM card 180 stores a unique telephone number.

A camera unit 140 photographs image data, and includes a camera sensor for converting a photographed optical signal to an electric signal and a signal processor for converting an analogue image signal photographed from the camera sensor to digital data. Here, it is assumed that the camera sensor is a CCD sensor or a CMOS sensor, and the signal processor can be implemented in a Digital Signal Processor (DSP). Further, the camera sensor can be integrally or separately formed with the signal processor.

An image processor 150 performs an Image Signal Processing (ISP) for displaying an image signal output from the camera unit 140 on a display unit 160. The ISP performs a function, such as a gamma correction, an interpolation, a spatial change, an image effect, an image scale, Auto White Balance (AWB), Auto Exposure (AE), and Auto Focus (AF). Therefore, the image processor 150 processes an image signal output from the camera unit 140 frame by frame, and outputs the frame image data in accordance with a characteristic and a size of the display unit 160. Further, the image processor unit 150 includes an image codec, and compresses the frame image data displayed on the display unit 160 in a preset scheme or restores the compressed frame image data to the original frame image data. Here, the image codec may include a JPEG codec, an MPEG4 codec, a Wavelet codec, etc. The image processor 150 is assumed to have an On Screen Display (OSD) function and outputs OSD data in accordance with a screen size displayed under the control of the controller 110.

The display unit 160 displays an image signal output from the image processor 150 on a screen and displays user data output from the controller 110. Here, the display unit 160 can be an LCD, and in this case, the display unit 160 can include an LCD controller, a memory capable of storing image data, and an LCD display device. Here, when the LCD is implemented in a touch screen scheme, the LCD can function as an input unit. In this regard, the display unit 160 can display keys, such as the keys included in the input unit 127.

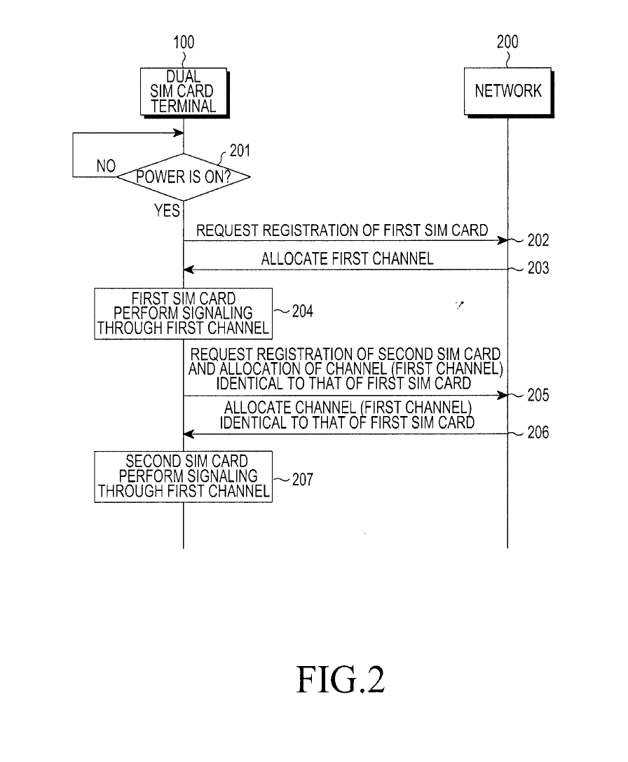

Hereinafter, an operation of reducing the consumption of the electric current in the dual SIM card terminal will be described with reference to FIG. 2 in detail.

FIG. 2 is a flowchart illustrating a process of reducing the consumption of the electric current in an idle state in the dual SIM card terminal according to an embodiment of the present invention.

Referring to FIGS. 1 and 2, when a power of the dual SIM card terminal is turned on, the controller 110 detects the turn-on state of the dual SIM card terminal and switches the dual SIM card terminal 100 to be in an idle state in step 201. In the idle state of the dual SIM card terminal 100, the controller 110 transmits a request for network registration of the first SIM card 170 to the network 200 in step 202.

When a first channel is allocated to the dual SIM card terminal 100 from the network 200 according to the request for the network registration of the first SIM card 170 in step 203, the controller 110 detects the allocation of the first channel and makes a control so that the first SIM card 170 performs a signaling through the first channel and maintains the identical channel in step 204. In the prior art, when the portable terminal is in the idle state, two SIM cards comprised in the portable terminal are allocated two different channels from the network, and the controller of the portable terminal performs the signaling through two allocated channels and maintains two channels. However, in the present invention, the controller of the potable terminal allocates one identical channel, so that the first SIM card and the second SIM card alternately perform the signaling at every predetermined time interval through the identical channel.

Then, the controller 110 makes a request for a network registration of the second SIM card 180 to the network so that allocation of channel identical to that of first SIM card (first channel) is allocated in step 205.

In response, the network 200 can allocate the first channel requested by the dual SIM card terminal 100 to the second SIM card 180 for signaling. That is, when the first channel, which is identical to the channel of the first SIM card 170, requested from the network 200 is allocated to the dual SIM card terminal 100 in step 206, the controller 110 detects the allocation of the first channel and makes a control so that the second SIM card 180 performs the signaling through the first channel and maintains the first channel in step 207. For the signaling by the first SIM card 170 and the second SIM card 180 through the identical first channel, the controller 110 makes a control so that the first SIM card 170 and the second SIM card 180 alternately perform the signaling at every predetermined time interval through the first channel.

In an alternate embodiment, which is not illustrated in FIG. 2, the controller 110 transmits a request for a network registration of the second SIM card 180 to the network 200 during an idle state of the dual SIM card terminal 100. When the first channel is allocated to the dual SIM card terminal 100 from the network 200 according to the request for the network registration of the second SIM card 180, the controller 110 detects the allocation of the first channel and makes a control so that the second SIM card 180 performs the signaling through the first channel and maintains the first channel. Then, the controller 110 makes a request for an allocation of the first channel, which is the identical channel allocated to the second SIM card 180, together with a request for a network registration of the first SIM card 110, to the network 200. When the requested first channel, which is the identical channel allocated to the second SIM card 180, is allocated to the dual SIM card terminal 100 from the network 200, the controller 110 detects the allocation of the first channel and makes a control so that the first SIM card 170 performs the signaling through the first channel and maintain the first channel. For the signaling by the second SIM card 180 and the first SIM card 170 through the identical first channel, the controller 110 makes a control so that the second SIM card 180 and the first SIM card 170 alternately perform the signaling every predetermined time interval through the first channel.

Table 1 below represents an entire electric current quantity consumed in the idle state of the dual SIM card terminal when the service providers of the first SIM card and the second SIM card are the same.

Referring to Table 1, when both of the service providers of the first SIM card and the second SIM card are Airtel, the electric current consumption is 2.7 mA, and when both of the service providers of the first SIM card and the second SIM card are Idea, the electric current consumption is 2.3 mA. Therefore, it can be recognized that when the service providers of the first SIM card and the second SIM card are different, a small quantity of the electric current is consumed.

TABLE 1

| Electric current | | First SIM card | | |
|---|---|---|---|---|
| consumption in idle state | | Vodafone | Airtel | Idea |
| Second | Vodafone | x | 4.3 | 3.6 |
| SIM card | Airtel | 4.5 | 2.7 | 2.9 |

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the present invention has been shown and described with reference to certain exemplary embodiments and drawings thereof, it will be understood by those skilled in the art that various changes in form and details may be made therein without departing from the spirit and scope of the invention as defined by the appended claims.

What is claimed is:

1. A device for reducing an electric current consumption in a dual SIM card terminal, comprising:
a first SIM card and a second SIM card; and
a controller to make a control so that the first SIM card and the second SIM card perform a signaling through an identical channel for a network registration and maintain the identical channel when a power of the dual SIM card terminal is turned on.

2. The device as claimed in claim 1, wherein the controller makes a control so that the first SIM card and the second SIM card alternately perform the signaling at every predetermined time interval through the identical channel and maintain the identical channel for the network registration.

3. The device as claimed in claim 1, wherein when the power of the dual SIM card terminal is turned on, the controller makes a request for a registration of the first SIM card to a network so that the identical channel can be allocated to perform the signaling by the first SIM card.

4. The device as claimed in claim 3, wherein the controller makes a request for a registration of the second SIM card, to the network so that the identical channel can be allocated to perform the signaling by the second SIM card.

5. The device as claimed in claim 1, wherein when different service providers of the first SIM card and the second SIM card share a frequency, the first SIM card and the second SIM card perform the signaling through the identical channel.

6. The device as claimed in claim 1, wherein when service providers of the first SIM card and the second SIM card are the same, the first SIM card and the second SIM card perform the signaling through the identical channel.

7. The device as claimed in claim 1, wherein when a service provider of a corresponding SIM card has previously registered allocation of a channel, which is required by the dual SIM card terminal, in the network, the first SIM card and the second SIM card perform the signaling through the identical channel.

8. A method for reducing an electric current consumption in a dual SIM card terminal, the method comprising:
allocating an identical channel to a first SIM card and a second SIM card for a network registration when a power of the dual SIM card terminal is turned on; and
when the identical channel is allocated to the first SIM card and the second SIM card, performing, by the first SIM card and the second SIM card, a signaling through the identical channel and maintaining the identical channel.

9. The method as claimed in claim 8, wherein allocating of the identical channel comprises:
allocating a channel to the first SIM card from the network according to a request for a registration of the first SIM card when a power of the dual SIM card terminal is turned on; and
making a request for an allocation of the channel identical to the channel allocated to the first SIM card when making a request for a registration of the second SIM card, to the network.

10. The method as claimed in claim 8, wherein allocating of the identical channel comprises:
allocating a channel to the second SIM card from the network according to a request for a registration of the second SIM card when the power of the dual SIM card terminal is turned on; and
making a request for an allocation of the channel identical to the channel allocated to the second SIM card when making a request for a registration of the first SIM card, to the network.

11. The method as claimed in claim 8, wherein the first SIM card and the second SIM card are controlled so that they alternately perform the signaling at every predetermined time interval through the identical channel.

12. The method as claimed in claim 8, wherein when different service providers of the first SIM card and the second SIM card share a frequency, the first SIM card and the second SIM card perform the signaling through the identical channel.

13. The method as claimed in claim 8, wherein when service providers of the first SIM card and the second SIM card are the same, the first SIM card and the second SIM card perform the signaling through the identical channel.

14. The method as claimed in claim 8, wherein when a service provider of a corresponding SIM card has previously registered allocation of a channel, which is required by the dual SIM card terminal, in the network, the first SIM card and the second SIM card perform the signaling through the identical channel.
